(19) United States
(12) Patent Application Publication
(10) Pub. No.: US 2004/0096174 A1
(43) Pub. Date: May 20, 2004

(54) Optical fiber having an expanded mode field diameter and methods of providing such a fiber

(76) Inventor: Kanishka Tankala, South Windsor, CT (US)

Correspondence Address: Peter J. Rainville, NUFERN, 7 Airport Park Road, East Granby, CT, 06026, US

(21) Appl. No.: 10/438,680

(22) Filed: May 15, 2003

Related U.S. Application Data
(60) Provisional application No. 60/381,241, filed on May 16, 2002.

(51) Int. Cl. G02B 6/20

(52) U.S. Cl. 385/125; 385/123

(57) ABSTRACT

Disclosed is an optical fiber article comprising an optical fiber having a core and a cladding disposed about the core. The cladding can have a normal effective refractive index that is lower than the refractive index of the core, and the optical fiber can include a selected section wherein the cladding has a selected effective refractive index that is substantially higher than the normal effective refractive index for expanding the mode field diameter of the fiber along the selected section to be substantially larger than the normal mode field diameter. The fiber can be microstructured optical fiber, and can be joined, such as by splicing, to another optical fiber or device.

### CROSS-REFERENCE TO RELATED APPLICATION

This application claims priority to provisional patent application No. 60/381,241, filed May 16, 2002 and entitled “Optical Fiber Having An Expanded Mode Field Diameter And Methods Of Providing Such A Fiber,” and which is herein incorporated by reference.

### FIELD OF THE INVENTION

The present invention relates to optical fibers and, more particularly, to improved optical fibers wherein the mode field diameter is changed, such as by being expanded.

### BACKGROUND

Conventional optical fiber is a highly desirable transmission medium for carrying data and other signals over long as well as short distances. Conventional optical fiber is low cost as well as low loss, has a high bandwidth, is flexible, and is not sensitive to electromagnetic interference. The bandwidth of a single optical fiber is enormous, especially when dense wavelength division multiplexing (DWDM) techniques are used to transmit numerous channels, each having a different wavelength, over a single fiber.

Typically, a conventional optical fiber includes a glass cladding disposed about and contacting a glass core. The core includes an index of refraction that is higher than an index of refraction of the cladding such that the light propagating in the core is largely confined to the core, such as, for example, via the phenomenon of total internal reflection from the cladding. The difference between the indices of refraction comprised by the core and cladding, which can be referred to as the ΔN (“delta n”) of the fiber, can be created by introducing appropriate dopants into the core glass, the cladding glass, or into both the core glass and the cladding glass. Commonly used dopants include germanium, fluorine, phosphorus, boron, and aluminum.

Conventional optical fiber is not without some disadvantages. Conventional fiber does attenuate the light propagating in the fiber, and lower attenuation fiber would be useful and allow for reduced system complexity and cost, especially in long haul systems. Typically, conventional fiber best confines light in the core for a rather small range of angles of incidence. Bending the fiber through too tight a radius can cause light in the core to strike at an angle of incidence that is too high, such that the light is no longer confined to the core. Many devices, such as erbium doped fiber amplifiers (EDFAs) and Dispersion Compensating Modules (DCMs), require long lengths of fiber coiled inside a housing, and the minimum bend radius of the fiber limits how small the device can be made. Furthermore, in many instances conventional fiber is useful only over a transmission window of wavelengths from a longer wavelength, known as the bend edge, above which the signal is not sufficiently guided by the core, to a shorter wavelength, known as the cutoff wavelength, where a second mode can propagate along the fiber. The wavelengths in this window are determined by the radius of the core of the fiber and the ΔN. Accordingly, each different application can require a different fiber, (i.e., different ΔN and/or core radius) that has a cutoff wavelength optimized for the particular application. Finally, conventional fiber is dispersive and can distort signals, especially at higher data rates.

Accordingly, certain fibers, such as microstructured fibers, that do not have one or more of the foregoing disadvantages are of interest. A microstructured fiber can include a cladding having a longitudinally extending array of “features” that have a different refractive index than a portion of the cladding surrounding the features and a core about which the cladding is disposed. Often the features are voids. The potential advantages of microstructured fiber include lower loss than conventional fiber, better performance when bent, endless single mode propagation (i.e., there is no cutoff wavelength) and lower dispersion. Although microstructured fibers can include dopants, (e.g., the core can be doped with a rare earth to make a laser or amplifier), typically they do not primarily rely on doping to achieve an index difference between the core and cladding. The longitudinally extending features play a major role in causing light to be confined to the core. In one type of microstructured fiber, the features change the effective index of refraction of the cladding by taking the place of the otherwise present cladding material. The core is usually solid and includes the same type of material as the cladding.

Despite having certain advantages over conventional fiber, microstructured fiber should also be versatile and have other capabilities not specifically enumerated above if it is to be widely adopted. For example, it can be important that a fiber efficiently transfer light with another optical device, such as another fiber, light emitting diode, or laser. Efficient light transfer between devices is enhanced when the mode field diameters (MFDs) of the devices are matched. The MFD of a fiber refers to the width of the light beam associated with a selected transmission mode or modes of the fiber, as determined according to an agreed upon technique. For example, when splicing one conventional fiber to another conventional fiber having a different MFD, the core of the fiber having the smaller MFD can be expanded to expand the MFD for a more efficient transfer of light between the fibers. Unfortunately, regarding microstructured and other fibers, applicants are not aware of similar techniques for effecting more efficient transfer of light, or that the problem has even been considered in detail in relation to microstructured fibers.

Accordingly, it is an object of the present invention to address one or more of the foregoing and other deficiencies in the prior art.

### SUMMARY OF THE INVENTION

Applicants have considered the problem of efficient energy transfer with an optical fiber and have realized that certain processes relied upon in varying the MFD of a conventional fiber may be difficult to employ in certain circumstances, and especially with microstructured fibers. Consideration of this problem has led to the present invention, which can include varying the MFD of a fiber by varying the index of refraction of the cladding rather than by relying primarily on changing the size of the core of the fiber and/or on changing the index of refraction of the core of the fiber.

Prior techniques have focused on changing the MFD by diffusing index raising dopants present in the core into the cladding (or index lowering dopants present in the cladding to the core) to expand the size of the core and to concomitantly reduce the index of refraction of the core. Because the MFD of the fiber is a function of the size of the core and of the ΔN of the fiber, expanding the core and reducing the ΔN by lowering the index of refraction of the core both contribute to a change in the MFD. See, for example, U.S. Pat. No. 6,275,627 B1, entitled “Optical Fiber Having An Expanded Mode Field Diameter And Method Of Expanding The Mode Field Diameter Of An Optical Fiber,” issued Aug. 14, 2001 to Qi Wu, and assigned to Corning Incorporated.

However, some fibers, such as microstructured fibers, may not include significant concentrations of dopants in the core or the cladding, or dopants may be present in equal or nearly equal concentrations in both the core and the cladding. In such circumstances significant diffusion is unlikely. Also, the cladding can be made of the same type of material as the core and have substantially the same index of refraction as the core.

Accordingly, the invention can reside in raising the index of refraction of the cladding, additionally or alternatively to expanding the core or reducing the index of refraction of the core, thereby reducing ΔN and contributing to a change in the MFD of the fiber. Matter having a selected index of refraction can be disposed in the voids, and/or the diameter of the voids can be varied. Other aspects of the invention are described below.

In one aspect, there is provided according to the invention a microstructured optical fiber comprising a core for propagating light; a cladding disposed about the core and including a longitudinally extending array of voids; and an end face region, at one end of the fiber, for receiving or emanating light. A first section of the microstructured fiber can have a normal mode field diameter and a second section of the microstructured fiber terminating at the end face region and can have a second mode field diameter that is substantially larger than the normal mode field diameter.

The second mode field diameter can monotonically increase from a location further from the end face region to a location nearer the end face region. At a location along the second section each of a plurality of the voids can have a diameter that is substantially different than a diameter of that void at a location along the first section of the fiber. The plurality of voids can have diameters that monotonically decrease from a location farther from the end face region to a location nearer to the end face region. Along the second section at least some of the voids can include matter having a selected index of refraction disposed therein for making the second mode field diameter larger.

In another aspect, the invention provides a spliced optical fiber article having two optical fibers spliced together, comprising a microstructured optical fiber having a core and a cladding disposed about the core, with the cladding including a longitudinally extending array of voids, where a first section of the microstructured optical fiber has a normal mode field diameter and a selected section has an expanded mode field diameter that is substantially greater than the normal mode field diameter. A second optical fiber has a second mode field diameter that is greater than the normal mode field diameter, and the microstructured optical fiber and the second optical fiber are spliced such that the selected section of the of the microstructured optical fiber is joined with the second optical fiber. The expanded mode field diameter can be greater than the normal mode field diameter and less than the second mode field diameter for reducing the splice loss of the spliced optical fiber article.

At least some of the voids present along the selected section can have matter disposed therein. The matter can be disposed in at least some voids prior to splicing the microstructured fiber and the second optical fiber. The matter can include solid polymer or solid glass, and the solid matter can have been disposed in at least some of the voids when the matter was in a liquid state. At a location along the first section of the fiber the cladding can have a first effective refractive index, and at a location along the second section of the fiber the cladding can have a second effective refractive index that is substantially less than the first effective refractive index. The expanded mode field diameter of the spliced optical fiber article can monotonically increase from a location farther from the second fiber to a location nearer the second fiber. At a location along the second section each of a plurality the voids can have a diameter substantially different than a diameter of that void at a location along the first section of the fiber. The plurality of voids can have diameters that monotonically decrease from a location farther from the end face region to a location nearer to the end face region. In one practice, the selected section is no greater than one centimeter in length.

In yet another aspect, the invention provides an optical fiber article comprising a microstructured optical fiber having a core for propagating light and a cladding disposed about the core. The cladding can include a longitudinally extending array of voids, and the microstructured optical fiber can have a first section having a normal mode field diameter and a second section wherein a plurality of the voids include matter disposed therein such that at a location along the second section the fiber has a second mode field diameter that is substantially larger than the normal mode field diameter.

The matter can include a polymer or a glass. The matter can be a solid that was in a liquid state when disposed in the plurality of voids. In one practice, the second section is no greater than one centimeter in length. The second section can terminate in an endface region for radiating or receiving light, and the end face region can be a cleaved end of the microstructured optical fiber. The optical fiber article can include another fiber spliced with the second section of the microstructured optical fiber, where the other fiber has a third mode field diameter, and the second mode field diameter is less than the third mode field diameter for tending to reduce the splice loss to the another fiber.

In a yet a further aspect, the invention provides an optical fiber article comprising a microstructured optical fiber having a core for propagating light and a cladding disposed about the core, wherein the cladding includes a longitudinally extending array of voids. The microstructured optical fiber can include a first section having a normal mode field diameter and a selected section wherein for a plurality of the voids, each void has a diameter that is substantially different than the diameter of that void at a location along the first section of the fiber. The substantially different diameters can expand the mode field diameter to be larger along the selected section than the normal mode field diameter.

The diameters of the plurality of voids can monotonically decrease from a location nearer to the first section of fiber to a location farther from the first section of the fiber. In one practice, the selected section is no greater than one centimeter in length. The selected section can terminate in an endface region for one of radiating and receiving light. The optical fiber article can include another fiber spliced with the selected section of the microstructured optical fiber, wherein the other fiber has a third mode field diameter, and the second mode field diameter is less than the third mode field diameter for tending to reduce the splice loss to the other fiber.

In an additional aspect, the invention provides an optical fiber article, comprising an optical fiber having a core and a cladding disposed about the core, where the cladding has an normal effective refractive index that is lower than the refractive index of the core, and the optical fiber includes a selected section wherein the cladding has a selected effective refractive index that is substantially higher than the normal effective refractive index for expanding the mode field diameter of the fiber along the selected section of the optical fiber to be substantially larger than the normal mode field diameter. The core can have a diameter that is substantially the same along the optical fiber, and/or the core can have refractive index that is substantially the same along the optical fiber.

The present invention also involves methods as well as apparatus. For example, in one aspect, there is provided a method of providing an optical fiber article, comprising providing a section of optical fiber having a core, a cladding disposed about the core and a normal mode field diameter, wherein the cladding comprises an effective refractive index that is less than the core for tending to confine light propagating in the core to the core; and raising the effective refractive index of the cladding over a selected section of the fiber, the selected section shorter than the section, whereby the selected section has a second mode field diameter that is substantially different than the normal mode field diameter. The foregoing can include refraining from substantially changing the refractive index of the core of the fiber, as well as refraining from substantially changing the diameter of the core of the fiber.

Providing a section of optical fiber can include providing a section of a microstructured optical fiber wherein the cladding includes a longitudinally extending array of voids. Lowering the effective refractive index of the cladding can include disposing matter in a plurality of the voids present along the selected section. The matter can include a polymer or a glass. The matter can be a solid that was disposed in the voids when in a liquid state. In another aspect of the invention, lowering the effective refractive index of the cladding can include reducing the diameters of a plurality of the voids. Lowering the effective refractive index of the cladding can also include heating the fiber. The method can include shortening the selected section such that that second mode field diameter has a selected size at one end of the shortened selected section. In one practice, the method can also include forming an end face region at the one end for radiating or receiving light. Another fiber having a mode field diameter larger than the normal mode field diameter can be spliced to one end of the selected section of the fiber.

Further advantages, novel features, and objects of the invention will become apparent from the following detailed description of non-limiting embodiments of the invention when considered in conjunction with the accompanying FIGURES, which are schematic and which are not drawn to scale. For purposes of clarity, not every component is labeled in every one of the following FIGURES, nor is every component of each embodiment of the invention shown where illustration is not considered necessary to allow those of ordinary skill in the art to understand the invention.

### BRIEF DESCRIPTION OF THE DRAWINGS

FIG. 1 illustrates a cross section of a prior art optical fiber having an expanded core;

FIG. 2 illustrates a cross section of an optical fiber according to the present invention;

FIG. 3 is a cross section of a one embodiment of a microstructured optical fiber according to the present invention;

FIG. 4 is a cross section of the optical fiber of FIG. 3 taken along section line 4-4 of FIG. 3;

FIG. 5 is a cross section of another embodiment of a microstructured optical fiber article according to the present invention;

FIG. 6 is illustrates one technique for providing the embodiment of the invention shown in FIG. 3;

FIG. 7 illustrates another technique for providing the embodiment of the invention shown in FIG. 3; and

FIG. 8 illustrates a technique for providing the embodiment of the invention shown in FIG. 5.

### DETAILED DESCRIPTION OF THE PREFERRED EMBODIMENTS

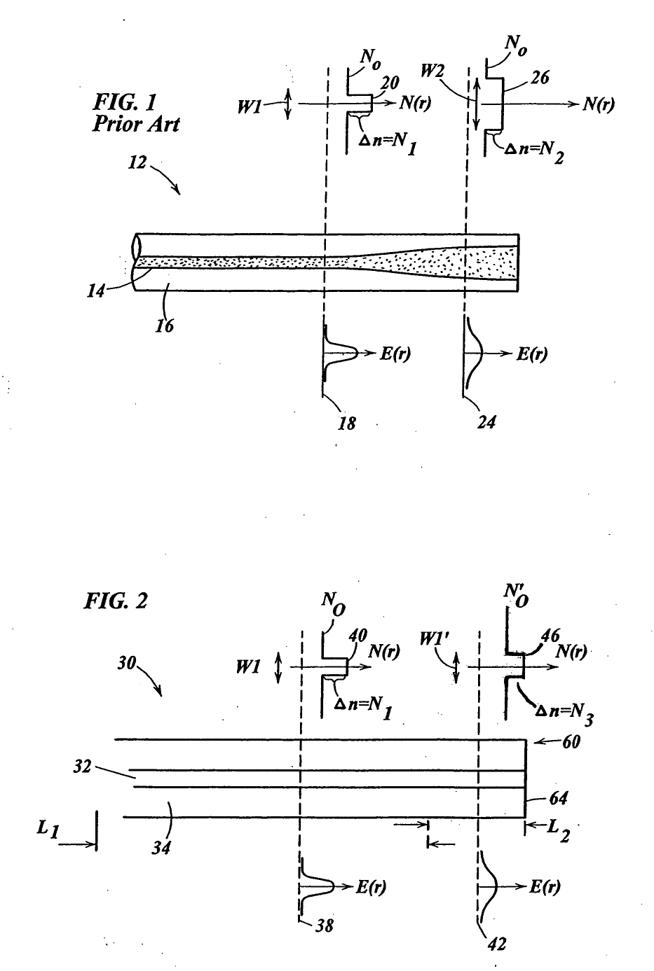

FIG. 1 illustrates a cross-section of a prior art optical fiber 12 having a core 14 and a cladding 16 disposed about and contacting the core 14. At a certain location 18 along the length of the optical fiber 12, the optical fiber 12 has a mode field distribution E(r) and an index of refraction profile N(r). The index of refraction profile N(r) is a step function having a width W₁ and a height ΔN=N₁. The index of refraction of the cladding is N₀ and the absolute height of the step, as indicated by 20, is therefore N₀+N₁. The optical fiber 12 is a conventional fiber where either the core 14 or the cladding 16 or both include dopants, such as GeO₂, in a host glass (typically silica) for providing the index of refraction profile having a width W₁ and a ΔN of N₀.

At a different location 24, the optical fiber 12 has a mode field distribution E(r) that is wider than the mode field distribution at the location 18. Note that the core 12 of the optical fiber 14 is considerably expanded at the location 24 such that the index of refraction function N(r) is a step function having a width W₂ greater than the width W₁. Note also that the index of refraction of the cladding N₀ remains largely the same but that the step ΔN of the index refraction profile is now equal to N₂, where N₂ is less than N₁. Thus, the height of the index refraction profile indicated by reference numeral 26 is equal to N₀+N₂ where N₀+N₂ is less than N₀+N₁. The combination of the expanded diameter of the core 14 and the lower ΔN of the fiber at the location 24 both contribute to expanding the mode field distribution E(r). Mode field diameter (MFD), as is understood by one of ordinary skill in the art, is a measure of the width of the mode field distribution plots E(r) shown in FIG. 1. Such measurement is done in accordance with an agreed upon procedure, so as to allow the comparison of MFDs. For example, one measure is the width where the E(r) plot has fallen to 1/e of its peak value.

As is known by those of ordinary skill in the art, the MFD of the conventional optical fiber 12 can be expanded at location 24 by selectively heating the optical fiber 12. Because the optical fiber 12 includes dopants in at least one of the core 14 or the cladding 16, heating the fiber 12 can cause the dopants to diffuse. In one practice, heating the fiber 12 causes germanium in the core 12 to outwardly diffuse into the cladding 16 thereby expanding the core 14 such as at location 24. If the cladding 16 is doped with fluorine, which is a down dopant, the fluorine from the cladding 16 can also diffuse into the core 14. The net effect is that the width of the core 12 increases and its index of refraction decreases, both of which contribute to expanding the MFD. As noted above, expanding the MFD of the fiber 12 can be very advantageous in providing efficient optical communication between the fiber 12 and another optical device.

FIG. 2 illustrates an optical fiber 30 according to the present invention. The optical fiber 30 includes a core 32 and a cladding 34 disposed about and preferably contacting the core 32. In general, the cladding 34 includes a lower effective refractive index than the refractive index of the core 32 for tending to confine light propagating in the core 32 to the core 32. For purposes of comparison, the mode field distribution E(r) and the step index N(r) at a location 38 are shown to be substantially equal to the mode field distribution E(r) and the index refraction profile N(r) of the optical fiber 12 at location 18. The mode field distribution E(r) at location 38 of the optical fiber 30 has a width W₁ and a ΔN of N₁. The index refraction of the cladding 34 is shown as N₀ and the height of the index of refraction profile, indicated by reference numeral 40, is N₀+N₁.

At a location 42 along the length of the optical fiber 30 the mode field distribution E(r) is substantially different than the mode field distribution E(r) at location 38. In the embodiment of the invention shown in FIG. 2, the mode field distribution E(r) at location 42 is expanded such that it is wider than the mode field distribution E(r) at location 38. Note the index of refraction profile N(r) at location 42. The effective index of refraction of the cladding 34 is raised to N₀′ such that the step of the index of refraction profile has a value of ΔN=N₃. The height of the step index of refraction profile indicated by reference numeral 46 will typically be substantially equal to N₀+N₁. Because the ΔN of N₃ at location 42 is less than the ΔN of N₁ at location 38, E(r) at location 42 is wider than the E(r) at location 38. Hence the MFD of the fiber 30, is expanded.

In one practice of the invention, the diameter of the core 32 does not substantially change along the length of the fiber 30, such that the diameter of the core 32 at the location 38 is substantially the same as the diameter of the core at the location 42. Alternatively or additionally, the core comprises an index of refraction 38 that is substantially equal to an index of refraction comprised by the core at location 42. Depending on how the optical fiber 30 is processed to change the effective index of refraction of the cladding 34 at location 42, some change in the diameter and/or refractive index of the core 32 may occur that is in excess of the statistical variation that normally results from fabrication of the fiber 30. “Substantially”, as used above, means that the raising of the effective index of refraction of the cladding 34 contributes, at least as much as any variation in the refractive index or diameter of the core 32, to a change in the MFD at location 42.

The end 60 of the optical fiber can include an end face region 64 for receiving or emanating light, or the optical fiber 30 can be fusion spliced to another optical fiber. As is appreciated by one of ordinary skill, apprised of the disclosure herein, the end face region 64 can include a flat face, which can be useful for butt coupling the optical fiber 30 to another device, such as a planar waveguide or a VCSEL (Vertical Cavity Surface Emitting Laser), or can include other shapes, such as a wedge, cone and the like.

Typically, the fiber 30 includes a section L₁ having a normal MFD and a section L₂ having a MFD that is substantially different than the normal MFD. The MFD need not be constant along the section L₂, and preferably monotonically varies from a location farther from the end 60 of the optical fiber 30 to a location nearer the end 60 of the optical fiber 30. Accordingly, the effective refractive index of the cladding 34 also monotonically varies from a location farther from the end 60 to a location nearer the end 60. For example, the MFD may increase along the section L₂ to have its largest value at or near the end face region 64, where it is matched (or more closely matched than the normal MFD of the optical fiber 30) to the MFD of the device with which the optical fiber 30 optically communicates. The effective refractive index of the cladding is substantially higher than the normal effective refractive index for expanding the MFD of the fiber 30 along the section L₂.

“Substantially different,” as used herein when referring to a difference or change in MFD, means that the difference exceeds the statistical variations in MFD present in the optical fiber 30. Similar considerations to the statement that the diameters of the voids of a microstructured fiber are “substantially different”—the difference or change is greater than statistical variations along the fiber. “Normal” is intended to mean that the parameter or quantity is within the typical statistical variations for the fiber 30.

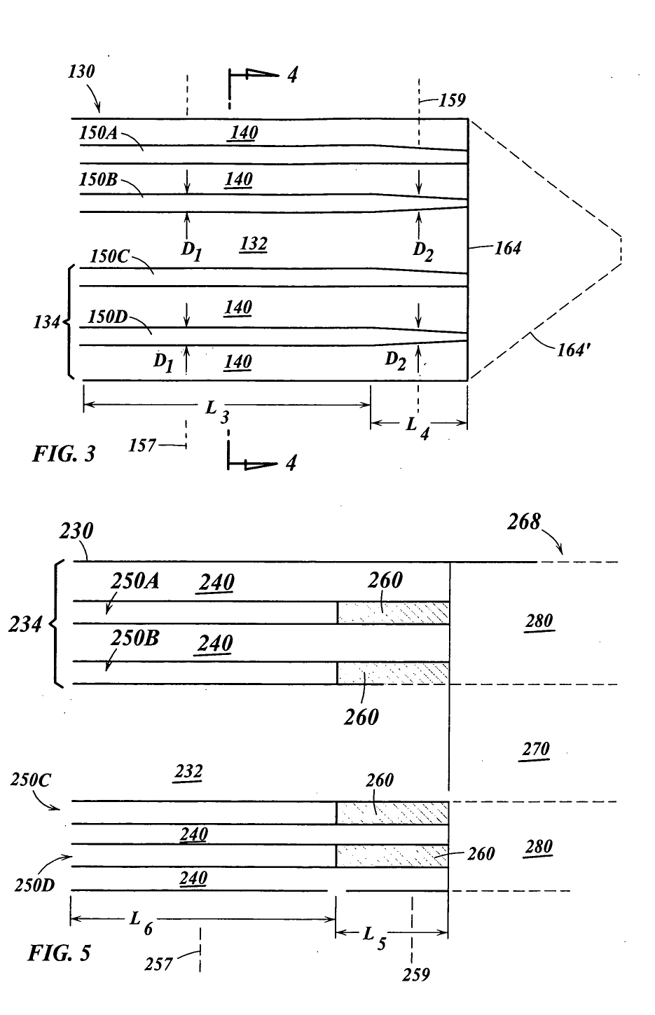

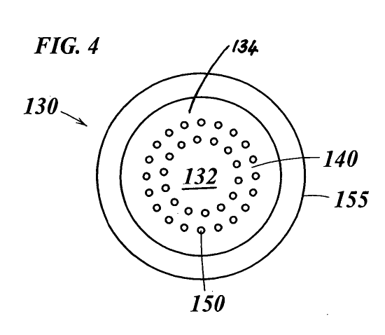

In a preferred embodiment of the invention, the optical fiber 30 is a microstructured optical fiber and, more particularly, is a microstructured optical fiber having a cladding that includes a longitudinally extending array of voids. FIG. 3 is a cross-section one embodiment of a microstructured optical fiber and is to be considered in conjunction with FIG. 4, which is a cross-section of the fiber of FIG. 3 taken along section line 4-4 shown in FIG. 3.

Techniques that can be used to fabricate microstructured fibers are known in the art. See, for example, U.S. Pat. No. 5,802,236, entitled “Article Comprising A Microstructured Optical Fiber, And Method of Making Such A Fiber,” issued on Sep. 1, 1998 to DiGiovanni et al., and assigned at the time of issue to Lucent Technologies Inc., Murray Hill, N.J.; and U.S. Pat. No. 6,260,388 B1, entitled “Method Of Fabricating Photonic Glass Structures By Extruding, Sintering And Drawing,” issued to Borrelli et al. on Jul. 17, 2001, and assigned at the time of issue to Corning Incorporated; and WO 99/00685, entitled “Single Mode Optical Fiber,” published Jan. 7, 1999, and which lists the inventors as Birks et al. and the applicant as the Secretary of State for Defence, GB.

With reference to FIGS. 3 and 4, a microstructured optical fiber 130 according to the invention can include a core 132 for propagating light and a cladding 134 disposed about and typically contacting the core 130. The cladding includes a cladding material, indicated by reference numeral 140, which defines a longitudinally extending array of voids 150. For the purposes of clarity, FIG. 3 only shows a few of the voids 150 shown in FIG. 4. More specifically, FIG. 3 shows four voids, namely, 150A-150D, and the diameters of those voids are enlarged for purposes of illustration. As shown in FIG. 4, the microstructured optical fiber 130 can also include an outer protective coating 155. The use of such a coating 155 is common to prevent micro cracks in the cladding 134 of the fiber 130 from propagating and damaging the optical fiber 130.

As understood by those of ordinary skill in the art, the effective index of refraction of the cladding 134 can be conceptually considered as an appropriate weighted (typically by cross-sectional area) average of the indices of refraction of the cladding material 140 and the voids 150. (For a conventional fiber having a uniform glass cladding, the “effective” refractive index of the cladding is typically simply the refractive index of the glass of the cladding). The distribution and diameter of the voids 150 are selected so as to provide a desired ΔN, as is known in the art. It is not necessary that all the voids 150 have the same diameter, or that the voids 150 be uniformly distributed in the cladding. Typically, the normal diameter of the voids is on the order of microns or tens of microns. For example, the voids can have a diameter of 2-90 microns. The effective index of refraction of the cladding 134 is thus less than the index of refraction of the cladding material 140 because the voids 150 displace some of the material 140. The voids 150 can be evacuated, can include a gas, such as air, or can include a liquid or solid, as noted elsewhere herein.

According to one practice of the invention, the microstructured optical fiber 130 includes a normal MFD along section L₃, which MFD is determined at least in part by the ΔN of the fiber 130 and the diameter of the core 132. Along the section L₃ the diameters D₁ of the voids 150B and 150D remain substantially constant, subject only to the normal statistical variations due to the draw or other processes, such as extrusion, used to manufacture the microstructured optical fiber 130. As noted above, not all the voids need to have the same diameter, though for purposes of clarity in FIG. 3, the voids 150A and 150B are both shown as having the diameter D₁ at location 157.

The microstructured optical fiber 130 also includes another section L₄ wherein for a plurality of the voids (e.g., 150B and 150D), each void of the plurality (e.g., 150B) includes a diameter (e.g., the diameter D₂ at location 159) that is substantially different than the diameter of that void along the first section L₃ (e.g., the diameter D₁) of the microstructured optical fiber 130. Typically, the diameter of a given void of the plurality will be different than the diameter of that void along section L₃ for all locations along section L₄. Because the diameter of the voids 150B and 150D are substantially different at location 159 of section L₄ than along the section L₃, the MFD of the optical fiber 130 at location 159 will also be substantially different than the normal MFD. This is because the effective refractive index of the cladding 134 is changed due to the reduced diameters of the voids, which raises the effective index of refraction of the cladding 134.

Preferably, as indicated in FIG. 3, the plurality of the voids have diameters that monotonically decrease from a location farther from the end face region 164 of the microstructured optical fiber to a location that is nearer the end face region 164 (e.g., along the section L₄). Accordingly, the MFD of the optical fiber 130 will monotonically increase from a location farther from the end face region 164 to a location nearer the end face region 164. The end face region 164 is typically carefully formed so as to receive or emanate radiation in a selected manner. As indicated by the dashed line 164′, the end face region 164 can be shaped as a cone, a wedge or can have other shapes known to those of ordinary skill in the art to be useful in aiding with the radiation of light or the reception of light by the optical fiber 130. The endface region 164 can simply be a cleaved end of the fiber 130 or other flat face.

Although only two voids, namely voids 150R and 150D, are specifically shown as having diameters that are reduced from normal along the section L₄, one of ordinary skill readily understands that the change in MFD is related to the number of voids having reduced diameters. Typically most if not all of the voids 150 in the fiber 130 have diameters that are reduced along the section L₄.

FIG. 5 illustrates another embodiment of a microstructured optical fiber according to the present invention. The microstructured optical fiber 230 includes a core 232 for propagating light and a cladding 234 disposed about and contacting the core 232. As is known to those of ordinary skill in the art, the cladding 234 includes an effective refractive index that is less than the refractive index of the core 232 for tending to confine light propagating in the core 232 to the core 232. The cladding 234 includes a longitudinally extending array of voids; however, as with FIG. 3, only a few of the voids, namely, voids 250A to 250D, are shown. A first section of the fiber 230 indicated by L₆ has a normal MFD, such as the MFD at location 257. The MFD of the optical fiber 230 is substantially different than the normal MFD, at least at location 259 along the section L₅, due to the presence of a matter 260 that is disposed within the voids 250A to 250B. Typically, this matter 260 includes a polymer having a selected index of refraction and that is disposed in the fiber when the polymer is in a liquid state. Subsequently, the polymer solidifies or is solidified. The matter 260 can also be a glass, such as a borosilicate glass, that is disposed in the voids 250 when in a liquid state. The index refraction of the matter 260 can be selected to provide a desired MFD along the section L₅. To expand the MFD diameter to be larger than the normal MFD, the matter 260 has an index of refraction that is less than the index of refection of the cladding material 240 that surrounds the voids 250. To reduce the MFD, the matter 260 can comprise an index of refraction that is greater thatn the index of refraction of the cladding material 240 that surrounds the void 250.

Preferably the sections L₂, L₄ and L₅ shown in FIGS. 2, 3 and 5, respectively, are each no greater than 1 cm in length. More preferably, the sections L₂, L₄ and L₅ are each no greater than 1 mm in length.

The optical fiber 230 is shown as spliced to another optical fiber 268 having a core 270 and a cladding 280 disposed about and contacting the core 270. The MFD of the fiber 268 is typically larger than the normal MFD of the optical fiber 230. The MFD at a location along section L₅ is larger than the normal MFD along the section L₆, and less than the MFD of the fiber 230. Accordingly, section L₅ can provide a transition between the normal MFD of the fiber 230 and the MFD of the other optical fiber 268, and can reduce splice loss between the optical fiber 230 and the optical fiber 268. The fiber can be a conventional fiber having a solid glass core and a solid cladding.

Returning momentarily to FIG. 3, note that one or both of the diameter of the core 132 and the index of refraction of the core 132 remain substantially the same over the section L₃ and the section L₄. Similarly, the diameter of the core 232 can be substantially the same over the sections and L₅ and L₆. The refractive index of the core 232 of fiber 230 can be substantially the same as well. Some change may be induced by the manner in which the diameters of the voids 150A and 150D are reduced over the section L₄ or the manner in which the matter 250 is introduced into the voids 250A and 250D of the microstructured optical fiber 230.

Although the optical fiber 230 is shown as spliced to another optical fiber 268 in FIG. 5 and the fiber 130 is shown as terminating in end face region 164 in FIG. 3, one of ordinary skill in the art, in light of the disclosure herein, realizes that the optical fiber 230 could similarly include an end face region and that the optical fiber 130 could be spliced to another fiber in the manner shown for microstructured optical fiber 230 of FIG. 5.

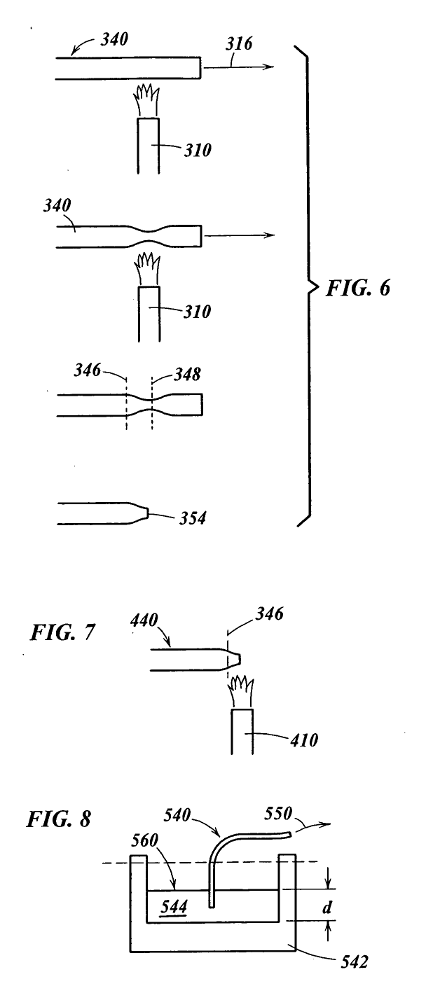

FIG. 6 illustrates one technique for providing the embodiment of the invention shown in FIG. 3. As shown in FIG. 6, a microstructured optical fiber 340 can be selectively heated such as by a heat source 310, which in FIG. 6 is a torch. A force 316 can be applied to one end of the fiber 340. The application 316 of heat to the fiber 340, alone or in combination with the application of the force 316, reduces the diameters of the voids in the fiber 340. The application of the force 316 is understood to aid in tapering the diameters of the voids such that they monotonically decrease as noted above, though it is also considered that the use of heat alone can taper the diameters of the voids.

As also shown in FIG. 6 the fiber can be truncated, such as along lines 346 or 348. For example, the fiber can be cleaved along line 346 or 348. Typically, the MFD of the fiber 340 at line 346 will be different than the MFD at line 348 and, in one practice of the invention, the fiber 340 is truncated at an appropriate location to provide a selected MFD. After truncation the fiber 340 can include end face region 354 for radiating or receiving light. The end face region 354 can be further processed such as by polishing or other shaping to provide for the appropriate reception or radiation of light. Although the heat source 310 shown in FIG. 6 is a torch, other heat sources, such as, for example a tungsten filament or an oven, can also be used.

As shown in FIG. 7, according to another practice of the invention, the microstructured optical fiber 440 can be heated at one end, such as after cleaving, by the heat source 410 to taper the diameters of the voids present at that end or adjacent to that end of the optical fiber. Again, the optical fiber can be truncated such as by cleaving along line 346 to provide for a selected MFD at the resultant end face, which can be further processed. It may be advantageous to pressurize the voids with a gas, such as nitrogen or other inert gas, to aid in tapering the diameters of the voids. Gas can be introduced to the voids via one or both ends of the fiber shown in FIG. 6, or via the free end of the fiber shown in FIG. 7.

FIG. 8 illustrates one method according to the present invention for disposing a selected material in the voids of the microstructured fiber 540. An end of the microstructured fiber 540 is disposed in a container 542 of selected matter 544, such as a liquid polymer or a molten glass, to a selected depth D. A vacuum 550 can be applied to one end of the fiber to aid in disposing the selected material within the voids of the microstructured fiber 540.

Alternatively or additionally, pressure 560 can be applied to the matter 544 to help dispose the matter 544 in the voids. Liquid polymers are available from a variety of sources, such as, for example, the Dow Chemical Corporation and DSM Desotech, both of the U.S.; NTT Advanced Technology Corporation of Tokyo, Japan; Terahertz Photonics of Livingston, Scotland; and Polymer Optics of Redfern, Australia. Such polymers are available in a variety of indices of refraction. Polymers that are cured via exposure to actinic radiation are available, such that the polymer can be solidified after being disposed in the voids.

Several embodiments of the invention have been described and illustrated herein. Those of ordinary skill in the art will readily envision a variety of other means and structures for performing the functions and/or obtain the results or advantages described herein and each of such variations or modifications is deemed to be within the scope of the present invention. More generally, those skilled in the art would readily appreciate that all parameters, dimensions, materials and configurations described herein are meant to be exemplary and that actual parameters, dimensions, materials and configurations will depend on specific applications for which the teaching of the present invention are used.

Those skilled in the art will recognize or be able to ascertain using no more than routine experimentation many equivalents to the specific embodiments of the invention described herein. It is therefore to be understood that the foregoing embodiments are presented by way of example only and that within the scope of the appended claims and equivalents thereto, the invention may be practiced otherwise than as specifically described. For example, although the present invention is considered to be of particular use with certain types of fibers, such as microstructured fibers, the invention can also be practiced with what have been described above as conventional fibers. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims as well as in the specification above all transitional phrases such as “comprising”, “including”, “carrying”, “having”, “containing”, “involving” and the like are understood to be open-ended, i.e., to mean “including but not limited to”. Only the transitional phrases “consisting of” and “consisting essentially of” shall be closed or semi-closed transitional phrases, respectively, as set forth in the U.S. patent Office Manual of patent Examining Procedure §2111.03, 7^{th} Edition, Revision 1.

We claim:

1. A microstructured optical fiber, comprising:
a core for propagating light;
a cladding disposed about said core, said cladding comprising a longitudinally extending array of voids;
an end face region at one end of said fiber, said end face region for one of receiving or emanating light;
a first section of said microstructured fiber having a normal mode field diameter; and
a second section of said microstructured fiber terminating at said end face region and having a second mode field diameter that is substantially larger than said normal mode field diameter.

2. The microstructured optical fiber of claim 1 wherein said second mode field diameter monotonically increases from a location farther from said end face region to a location nearer said end face region.

3. The microstructured optical fiber of claim 1 wherein at a location along said second section each of a plurality of said voids has a diameter that is substantially different than a diameter of that void at a location along said first section of said fiber.

4. The microstructured optical fiber of claim 3 wherein said plurality of voids have diameters that monotonically decrease from a location farther from said end face region to a location nearer to said end face region.

5. The microstructured optical fiber of claim 1 wherein along said second section at least some of said-voids include matter having a selected index of refraction disposed therein.

6. A spliced optical fiber article having two optical fibers spliced together, comprising:
a microstructured optical fiber having a core and a cladding disposed about said core, said cladding comprising a longitudinally extending array of voids, a first section of said microstructured optical fiber having a normal mode field diameter and a selected section having an expanded mode field diameter that is substantially greater than said normal mode field diameter;
a second optical fiber having a second mode field diameter that is greater than said normal mode field diameter;
said microstructured optical fiber and said second optical fiber being spliced such that said selected section of said microstructured optical fiber is joined with said second optical fiber; and
wherein said expanded mode field diameter is greater than said normal mode field diameter and less than or equal to said second mode field diameter for reducing the splice loss of said spliced optical fiber article.

7. The spliced optical fiber article of claim 6 wherein at least some of said voids present along said selected section have matter disposed therein, said matter having been disposed in said at least some voids prior to splicing said microstructured fiber and said second optical fiber.

8. The spliced optical fiber article of claim 7 wherein said matter includes a solid polymer disposed in said at least some voids when said polymer was in a liquid state.

9. The spliced optical fiber article of claim 6 wherein at a location along said first section of said fiber said cladding has a first effective refractive index, and wherein at a location along said second section of said fiber said cladding has a second effective refractive index that is substantially less than said first effective refractive index.

10. The spliced optical fiber article of claim 6 wherein said expanded mode field diameter varies monotonically from a location farther from said second fiber to a location nearer said second fiber.

11. The spliced optical fiber article of claim 6 wherein at a location along said second section each of a plurality said voids has a diameter substantially different than a diameter of that void at a location along said first section of said fiber.

12. The microstructured optical fiber of claim 11 wherein said plurality of voids have diameters that monotonically decrease from a location farther from said end face region to a location nearer to said end face region.

13. The spliced optical fiber article of claim 6 wherein said selected section is no greater than one centimeter in length.

14. An optical fiber article, comprising:
a microstructured optical fiber having a core for propagating light and a cladding disposed about said core, said cladding comprising a longitudinally extending array of voids;
said microstructured optical fiber having a first section having a normal mode field diameter; and
said microstructured optical fiber having a second section wherein a plurality of said voids include matter disposed therein such that at a location along said second section said fiber has a second mode field diameter that is substantially larger than said normal mode field diameter.

15. The optical fiber article of claim 14 wherein said matter includes a polymer.

16. The optical fiber article of claim 15 wherein said polymer is a solid polymer that was in a liquid state when disposed in said plurality of voids.

17. The optical fiber article of claim 14 wherein said second section is no greater than one centimeter in length.

18. The optical fiber article of claim 14 wherein said second section terminates in an endface region for one of radiating and receiving light.

19. The optical fiber article of claim 18 wherein said end face region is a cleaved end of said microstructured optical fiber.

20. The optical fiber article of claim 14 comprising another fiber spliced with said second section of said microstructured optical fiber, said another fiber having a third mode field diameter, and wherein said second mode field diameter is less than said third mode field diameter for tending to reduce the splice loss to said another fiber.

21. An optical fiber article, comprising:
a microstructured optical fiber having a core for propagating light and a cladding disposed about said core, said cladding comprising a longitudinally extending array of voids;
said microstructured optical fiber having a first section having a normal mode field diameter; and
said microstructured optical fiber having a selected section where for a plurality of said voids, each void has a diameter that is substantially different than the diameter of that void at a location along said first section of said fiber, said substantially different diameters for expanding the mode field diameter to be larger along said selected section than said normal mode field diameter.

22. The optical fiber article of claim 21 wherein the diameters of said plurality of voids monotonically decrease from a location nearer to said first section of fiber to a location farther from said first section of the fiber.

23. The optical fiber article of claim 21 wherein said selected section is no greater than one centimeter in length.

24. The optical fiber article of claim 21 wherein said selected section terminates in an endface region for one of radiating and receiving light.

25. The optical fiber article of claim 21 comprising another fiber spliced with said selected section of said microstructured optical fiber, said another fiber having a third mode field diameter, and wherein said second mode field diameter is less than said third mode field diameter for tending to reduce the splice loss to said another fiber.

26. An optical fiber article, comprising
an optical fiber having a core and a cladding disposed about said core, said cladding having a normal effective refractive index that is lower than the refractive index of said core, said optical fiber comprising a selected section wherein said cladding has a selected effective refractive index that is substantially higher than said normal effective refractive index for expanding the mode field diameter of said fiber along said selected section of the optical fiber to be substantially larger than said normal mode field diameter.

27. The optical fiber article of claim 26 wherein said core has a diameter that is substantially the same along said optical fiber.

28. The optical fiber article of claim 26 wherein said core has a refractive index that is substantially the same along the optical fiber.

29. A method of providing an optical fiber article, comprising:
providing a section of optical fiber having a core, a cladding disposed about the core and a normal mode field diameter, the core having an effective refractive index that is less than the core for tending to confine light propagating in the core to the core; and
raising the effective refractive index of the cladding over a selected section of the fiber, the selected section shorter than the section;
whereby the selected section has a second mode field diameter that is substantially different than the normal mode field diameter.

30. The method of claim 29 comprising refraining from substantially changing the refractive index of the core of the fiber.

31. The method of claim 29 comprising refraining from substantially changing the diameter of the core of the fiber.

32. The method of claim 29 wherein providing a section of optical fiber includes providing a section of microstructured optical fiber wherein the cladding includes a longitudinally extending array of voids.

33. The method of claim 32 wherein lowering the effective refractive index of the cladding includes disposing matter in a plurality of the voids present along the selected section.

34. The method of claim 33 wherein the matter includes a polymer disposed in the plurality of the voids when in a liquid state.

35. The method of claim 32 wherein lowering the effective refractive index of the cladding includes reducing the diameters of a plurality of the voids.

36. The method of claim 32 wherein lowering the effective refractive index of the cladding includes heating the fiber.

37. The method of claim 29 comprising shortening the selected section such that said second mode field diameter has a selected size at one end of the shortened selected section.

38. The method of claim 37 comprising forming an end face region at the one end for one of radiating and receiving light.

39. The method of claim 32 comprising splicing another fiber having a mode field diameter larger than the normal mode field diameter onto one end of the selected section of the fiber.
